(19) United States
(12) Patent Application Publication
(10) Pub. No.: US 2015/0059605 A1
(43) Pub. Date: Mar. 5, 2015

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM CORPORATION, Tokyo (JP)

(72) Inventor: Kazuhiro HAMADA, Haibara-gun (JP)

(73) Assignee: FUJIFILM CORPORATION, Tokyo (JP)

(21) Appl. No.: 14/471,019

(22) Filed: Aug. 28, 2014

(30) Foreign Application Priority Data
Aug. 30, 2013 (JP) 2013-180176

(51) Int. Cl. B41N 1/00; C08L 53/02; B23K 26/40; B23K 26/14; B23K 26/36; C08L 47/00; C08L 9/00

(52) U.S. Cl. CPC B41N 1/00; C08L 47/00; C08L 53/025; C08L 9/00; B23K 26/1417; B23K 26/365; B23K 26/4065
USPC 101/395; 525/293; 525/301; 525/287; 525/291; 219/121.69

(57) ABSTRACT

Disclosed is a resin composition for laser engraving comprising (Component A) a polymer having a monomer unit derived from a conjugated diene-based hydrocarbon, (Component B) a compound having an acid group and an ethylenically unsaturated bond; and (Component C) a polymerization initiator.

### CROSS-REFERENCE TO RELATED APPLICATION

This application claims priority under 35 USC 119 from Japanese Patent Application No. 2013-180176 filed on Aug. 30, 2013, the disclosure of which is incorporated by reference herein.

### TECHNICAL FIELD

The present invention relates to a resin composition for laser engraving, a flexographic printing plate precursor for laser engraving and a process for producing the same, and a flexographic printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As a resin composition for laser engraving, those described in WO03/022594, or WO2009/102035 are known.

### SUMMARY OF INVENTION

Objects of the present invention are to provide a resin composition for laser engraving that is excellent in rinsing properties for engraving residue generated at the time of laser engraving and can give a flexographic printing plate excellent in ink resistance, to provide a flexographic printing plate precursor for laser engraving that uses the resin composition for laser engraving and a process for producing the same, and to provide a flexographic printing plate and a process for making the same.

The above objects of the present invention has been achieved by the following <1>, <9>, <11> and <13> to <16>. Preferable embodiments <2> to <8>, <10>, <12>, <14> to <15> will also be described below.

<1> A resin composition for laser engraving comprising: (Component A) a polymer having a monomer unit derived from a conjugated diene-based hydrocarbon; (Component B) a compound having an acid group and an ethylenically unsaturated bond; and (Component C) a polymerization initiator.
<2> The resin composition for laser engraving as described in <1>, wherein Component A contains a monomer unit derived from butadiene and/or isoprene.
<3> The resin composition for laser engraving as described in <1> or <2>, wherein Component B is a compound represented by the following Formula (1).

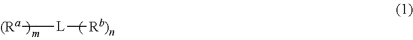

(In Formula (1), R^{a} denotes an ethylenically unsaturated bond; m denotes an integer from 1 to 3; R^{b} denotes an acid group; n denotes an integer of 1 or 2; and L denotes a single bond or an (m+n)-valent organic linking group which connects an ethylenically unsaturated bond and an acid group.)
<4> The resin composition for laser engraving as described in any one of <1> to <3>, wherein Component B has two or more ethylenically unsaturated bonds.
<5> The resin composition for laser engraving as described in any one of <1> to <4>, wherein the acid group that Component B has is selected from a group consisting of a carboxy group, a sulfonic acid group, and a phosphoric acid group.
<6> The resin composition for laser engraving as described in any one of <1> to <5>, wherein the acid group that Component B has is a carboxy group.
<7> The resin composition for laser engraving as described in any one of <1> to <6>, wherein an SP value of Component A is equal to or smaller than 9.0.
<8> The resin composition for laser engraving as described in <1> to <7>, further comprising (Component D) a photothermal conversion agent.
<9> A flexographic printing plate precursor for laser engraving comprising a crosslinked relief-forming layer obtained by crosslinking a relief-forming layer, which is formed of the resin composition for laser engraving as described in any one of <1> to <8>, by heat and/or light.
<10> The process for producing a flexographic printing plate precursor for laser engraving as described in <9>, wherein in the step of crosslinking, the relief-forming layer is crosslinked by heat.
<11> A process for producing a flexographic printing plate precursor for laser engraving, comprising steps of: forming a relief-forming layer formed of the resin composition for laser engraving as described in any one of <1> to <8>; and crosslinking the relief-forming layer by heat and/or light so as to obtain a flexographic printing plate precursor having a crosslinked relief-forming layer.
<12> The process for producing a flexographic printing plate precursor for laser engraving as described in <11>, wherein in the step of crosslinking, the relief-forming layer is crosslinked by heat.
<13> A process for making a flexographic printing plate, comprising steps of: preparing the flexographic printing plate precursor for laser engraving according to <9> or <10> or obtained by the production process according to <11> or <12>; and; and engraving the flexographic printing plate precursor for laser engraving with laser so as to form a relief layer.
<14> The process for making a flexographic printing plate according to <13> further comprising, after the step of engraving, a step of rinsing the surface of the relief layer with an aqueous rinsing liquid.
<15> The process for making a flexographic printing plate according to <14>, wherein pH of the aqueous rinsing liquid is equal to or higher than 10.
<16> A flexographic printing plate made by the process for making a flexographic printing plate as described in <13> to <15>.

### DESCRIPTION OF EMBODIMENTS

The present invention is explained in detail below.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

Furthermore, ‘(Component A) a polymer having a monomer unit derived from a conjugated diene-based hydrocarbon’ etc. are simply called ‘Component A’ etc.

Furthermore, in the present invention, ‘mass %’ and ‘wt %’ have the same meaning, and ‘parts by mass’ and ‘parts by weight’ have the same meaning.

Moreover, in the present invention a combination of the preferred embodiments explained below is a more preferred embodiment.

In the present specification, when a frexographic printing plate precursor is explained, a layer that comprises Component A to Component C, that serves as an image-forming layer subjected to laser engraving, that has a flat surface, and that is an uncrosslinked crosslinkable layer is called a relief-forming layer, a layer that is formed by crosslinking the relief-forming layer is called a crosslinked relief-forming layer, and a layer that has asperities formed on the surface by laser engraving the crosslinked relief-forming layer is called a relief layer.

### (Resin Composition for Laser Engraving)

The resin composition for laser engraving of the present invention (hereinafter, also simply called a ‘resin composition’) comprises (Component A) a polymer having a monomer unit derived from a conjugated diene-based hydrocarbon, (Component B) a compound having an acid group and an ethylenically unsaturated bond and (Component C) a polymerization initiator.

International Publication WO03/022594A discloses a photosensitive resin composition for a printing plate precursor that contains an inorganic porous material and makes it possible to perform laser engraving while inhibiting generation of engraving residue. Moreover, International Publication WO2009/102035A discloses a laser-engravable printing plate precursor, which contains resin having a siloxane bond on a main chain and/or a side chain and is excellently inhibited from being stained with ink, and a laser-engraved printing plate made of the precursor.

The present inventors found that the printing plate formed of the resin composition for laser engraving disclosed in International Publication WO03/022594A exhibits poor solvent ink resistance and exhibits insufficient washing performances with respect to an aqueous rinsing liquid. Moreover, they found that in the flexographic printing plate formed of the resin composition for laser engraving disclosed in International Publication WO2009/102035A, rinsing properties for engraving residue are insufficient.

As a result of thorough examination, the present inventors found that when a crosslinked relief-forming layer formed of a resin composition containing Component A to Component C is laser-engraved, rinsing properties for engraving residue are excellent. Furthermore, they also found that such a resin composition exhibits excellent ink resistance with respect to all of the solvent ink, UV ink, and aqueous ink.

The mechanism of action is unclear, but the following is assumed to be as the mechanism. That is, presumably, since the resin composition of the present invention contains Component A to Component C, an acid group may be introduced into a film formed of the resin composition, and this may help the engraving residue to become hydrophilic. It is assumed that by the action of the acid group, water solubility or water dispersibility of the engraving residue generated by laser engraving may be improved, and consequentially, rinsing properties for the engraving residue may be improved. Moreover, it is assumed that an olefin bond that the Component A has inside the main chain may be crosslinked with an ethylenically unsaturated bond that the Component B has, and consequentially, the acid groups that the Component B has may be appropriately dispersed in the Component A. Such an effect of improving rinsing properties is markedly exerted when a rinsing liquid is alkaline, and particularly, when an aqueous rinsing liquid having pH of equal to or higher than 10 is used, the effect is markedly exerted.

In addition, the mechanism of action that results in excellent ink resistance is unclear, but presumably, addition of Component B may improve the ink resistance.

The resin composition of the present invention can be widely used for forming resin objects that are laser-engraved, without particular limitation. For example, specifically, the resin composition of the present invention can be used for an image-forming layer of an image-forming material that is laser-engraved for forming an image, a relief-forming layer of a printing plate precursor that is laser-engraved for forming a convex relief, an intaglio printing plate, a stencil printing plate, and a stamp, but the use of the resin composition is not limited to these. In particular, the resin composition of the present invention can be suitably used for an image-forming layer of an image-forming material that is laser-engraved for forming an image and a relief-forming layer in a flexographic printing plate precursor for laser engraving.

Hereinafter, constituents of the resin composition for laser engraving will be described.

(Component A) Polymer Having a Monomer Unit Derived from a Conjugated Diene-Based Hydrocarbon

The resin composition for laser engraving of the present invention contains (Component A) a polymer having a monomer unit derived from a conjugated diene-based hydrocarbon. The Component A is a polymer component (binder resin) contained in the resin composition for laser engraving.

The weight average molecular weight of Component A is preferably 5,000 to 1,600,000, more preferably 10,000 to 1,000,000, and yet more preferably 15,000 to 600,000. If the weight average molecular weight is equal to or more than 5,000, Component A excellently maintains its shape as a simple resin. If the weight average molecular weight is equal to or less than 1,600,000, Component A easily dissolves in a solvent, and this is convenient for preparing a resin composition for laser engraving.

In the present invention, the weight average molecular weight is measured by gel permeation chromatography (GPC) and expressed in terms of standard polystyrene. Specifically, for example, HLC-8220 GPC (manufactured by TOSOH CORPORATION) is used as a GPC instrument; three columns including TSKgeL Super HZM-H, TSKgeL Super HZ4000, and TSKgeL Super HZ2000 (manufactured by TOSOH CORPORATION, 4.6 mm ID×15 cm) are used as columns; and THF (tetrahydrofuran) is used as an eluent. GPC is performed using an IR detector, under conditions in which a sample concentration is set to 0.35 mass %, a flow rate is set to 0.35 ml/min, an amount of sample injected is set to 10 μl, and a measurement temperature is set to 40° C. A calibration curve is prepared from eight samples including “F-40”, “F-20”, “F-4”, “F-1”, “A-5000”, “A-2500”, “A-1000”, and “n-propylbenzene” of “Standard sample TSK standard, polystyrene” manufactured by TOSOH CORPORATION.

Component A has at least a monomer unit derived from a conjugated diene-based hydrocarbon.

Preferable examples of Component A include a polymer obtained by polymerizing a conjugated diene-based hydrocarbon, a copolymer obtained by polymerizing a conjugated diene-based hydrocarbon with other unsaturated compounds, preferably monoolefin-based unsaturated compounds, and the like. The above polymer and copolymer may be modified. For example, a reactive group such as a (meth)acryloyl group may be introduced into the terminal thereof, or a portion of the olefin of the inside thereof may be hydrogenated. In the following description, polybutadiene in which a portion of olefin of the inside thereof has been hydrogenated is referred to as “partially hydrogenated polybutadiene”. Likewise, polyisoprene in which a portion of olefin of the inside thereof has been hydrogenated is referred to as “partially hydrogenated polyisoprene”. The copolymer may be one of the random copolymer, block copolymer, and graft copolymer, and is not particularly limited.

Specific examples of the conjugated diene-based hydrocarbon include 1,3-butadiene, isoprene, and chloroprene. With regard to these compounds, they may be used on their own or in a combination of two or more types.

Specific examples of the monoolefin-based unsaturated compound include styrene, α-methylstyrene, o-methylstyrene, p-methylstyrene, isobutene, (meth)acrylonitrile, vinyl chloride, vinylidene chloride, (meth)acrylamide, vinyl acetate, (meth)acrylic acid ester, (meth)acrylic acid.

Specific examples of polymers obtained by polymerization of the conjugated diene-based hydrocarbon and copolymers obtained by copolymerization of the conjugated diene-based hydrocarbon and the monoolefin-based unsaturated compound include, but are not particularly limited to, polybutadiene, polyisoprene, polychloroprene, a styrene-butadiene copolymer, a styrene-isoprene polymer, a styrene-chloroprene copolymer, an acrylonitrile-butadiene copolymer, an acrylonitrile-isoprene copolymer, an acrylonitrile-chloroprene copolymer, an acrylic acid ester-isoprene copolymer, an acrylic acid ester-chloroprene copolymer, a copolymer between a methacrylic acid ester and the conjugated diene, an acrylonitrile-butadiene-styrene copolymer, a styrene-isoprene-styrene block polymer, a styrene-butadiene-styrene block polymer, and an isobutene-isoprene block polymer (isobutylene-isoprene rubber). These polymers may be formed by emulsion polymerization or solution polymerization.

In the present invention, Component A may have an ethylenically unsaturated group on the terminal thereof or have a partial structure represented by the following Formula (A-1) on the terminal thereof.

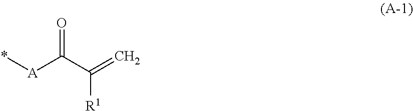

(In Formula (A-1), R¹ denotes an hydrogen atom or a methyl group, A denotes O or NH, and * denotes a binding site with other structures.)

In Formula (A-1), A is preferably O.

That is, Component A may have a (meth)acryloyloxy group or a (meth)acrylamide group in a molecule. It is more preferable for Component A to have a (meth)acryloyloxy group.

Component A may have the partial structure represented by Formula (A-1) on either the terminal of a main chain or a side chain, but it is preferable for Component A to have the partial structure on the terminal of a main chain.

From the viewpoint of printing durability, it is preferable for Component A to have two or more partial structures represented by Formula (A-1) in a molecule.

Examples of Component A having the partial structure represented by Formula (A-1) include polyolefin (meth)acrylate (for example, BAC-45 (manufactured by OSAKA ORGANIC CHEMICAL INDUSTRY LTD.), TEA-1000, TE-2000, and EMA-3000 (manufactured by NIPPON SODA CO., LTD.)) obtained by reacting an ethylenically unsaturated group-containing compound with a hydroxyl group of a hydroxyl group-containing polyolefin, such as polybutadiene di(meth)acrylate, partially hydrogenated polybutadiene di(meth)acrylate, polyisoprene di(meth)acrylate, and partially hydrogenated polyisoprene di(meth)acrylate.

Moreover, modified polyolefin (for example, methacrylate-introduced polyisoprene (Kuraprene UC-203 and UC-102 (manufactured by KURARAY CO., LTD.)) obtained by modifying polyolefin to introduce an ethylenically unsaturated bond thereinto is also preferably included in the examples.

<Polymer Having a Monomer Unit Derived from Butadiene and/or Isoprene>

In the present invention, it is preferable for Component A to be a polymer having a monomer unit derived from butadiene and/or isoprene.

Specific examples of the polymer include polybutadiene, partially hydrogenated polybutadiene, terminal-modified polybutadiene, polyisoprene, partially hydrogenated polyisoprene, terminal-modified polyisoprene, styrene butadiene rubber (SBR), a styrene-butadiene-styrene triblock copolymer (SBS), an acrylonitrile-butadiene-styrene copolymer (ABS), a styrene-isoprene-styrene triblock copolymer (SIS), an isoprene/butadiene copolymer, and the like.

Here, the “terminal-modified” means the terminal of a main chain or a side chain that has been modified with an amide group, a carboxy group, a hydroxy group, a (meth)acryloyl group, a glycidyl group, or the like.

Among these, polybutadiene, partially hydrogenated polybutadiene, hydroxyl group-terminal polybutadiene, glycidyl ether-modified polybutadiene, polyisoprene, partially hydrogenated polyisoprene, terminal-modified polyisoprene, hydroxyl group-terminal polyisoprene, glycidyl ether-modified polyisoprene, SBS, and SIS are preferable.

A proportion of the monomer unit derived from butadiene, isoprene, or hydrogenated butadiene or isoprene is preferably equal to or higher than 30 mol % in total, more preferably equal to or higher than 50 mol % in total, and yet more preferably equal to or higher than 80 mol % in total.

It is known that depending on the catalyst or reaction conditions, isoprene is polymerized by 1,2-addition, 3,4-addition, or 1,4-addition. In the present invention, the isoprene may be polyisoprene polymerized in any form of the addition. Among the polyisoprenes, from the viewpoint of obtaining intended elasticity, it is preferable for Component A to contain cis-1,4-polyisoprene as a main component. When Component A is polyisoprene, the content of cis-1,4-polyisoprene is preferably equal to or more than 50 mass %, more preferably equal to or more than 65 mass %, yet more preferably equal to or more than 80 mass %, and particularly preferably equal to or more than 90 mass %.

As the polyisoprene, either natural rubber or commercially available polyisoprene can be used. Examples of the commercially available polyisoprene include a NIPOL IR series (manufactured by ZEON CORPORATION).

It is known that depending on the catalyst or reaction conditions, butadiene is polymerized by 1,2-addition or 1,4-addition. In the present invention, the butadiene may be polybutadiene polymerized in any form of the addition. Among the polybutadienes, from the viewpoint of obtaining intended elasticity, it is more preferable for 1,4-polybutadiene to be a main component of Component A.

When Component A is polybutadiene, the content of 1,4-polybutadiene is preferably equal to or more than 50 mass %, more preferably equal to or more than 65 mass %, yet more preferably equal to or more than 80 mass %, and particularly preferably equal to or more than 90 mass %.

The content of a cis-isomer and a trans-isomer is not particularly limited, but from the viewpoint of obtaining rubber elasticity, a cis-isomer is preferable. The content of cis-1,4-polybutadiene is preferably equal to or more than 50 mass %, more preferably equal to or more than 65 mass %, yet more preferably equal to or more than 80 mass %, and particularly preferably equal to or more than 90 mass %.

As polybutadiene, commercially available products can be used. Examples of the commercially available products include a NIPOL BR series (manufactured by ZEON CORPORATION), a UBEPOL BR series (manufactured by UBE INDUSTRIES, LTD.), and the like.

It is preferable for Component A to be a polymer having a main chain which mainly has isoprene or butadiene as a monomer unit, and a portion of the polymer may be hydrogenated and converted into a saturated bond. In addition, the middle or terminal of main chain of the polymer may be modified with an amide group, a carboxy group, a hydroxy group, a (meth)acryloyl group, or the like or may be epoxylated.

From the viewpoint of solubility in a solvent or handleability, among the above polymers, polybutadiene, polyisoprene, and an isoprene/butadiene copolymer are preferable as examples of Component A. Among these, polybutadiene and polyisoprene are more preferable, and polybutadiene is yet more preferable.

From the viewpoint of obtaining flexibility and rubber elasticity, it is preferable for Component A to have a glass transition temperature (Tg) equal to or lower than 20° C.

The glass transition temperature of Component A is measured according to JIS K-7121-1987 by using a differential scanning calorimeter (DSC).

In addition, when Component A has two or more kinds of glass transition temperature, it is preferable for at least one of them to be equal to or lower than 20° C. It is more preferable for all of the glass transition temperatures to be equal to or lower than 20° C.

Component A has at least an ethylenically unsaturated group based on a conjugated diene-based hydrocarbon. As described above, Component A may further has an ethylenically unsaturated group on the terminal of a main chain or on a side chain, in addition to the above ethylenically unsaturated group.

In the present invention, it is preferable for an SP value of Component A to be equal to or smaller than 9.0. The SP value is also referred to as a solubility parameter or a solubility coefficient. The SP value is a measure of mixing properties between liquids.

If the SP value is equal to or smaller than 9.0, it is preferable since resistance to a solvent ink or a UV ink is improved.

The SP value is preferably 8.0 to 9.0, and more preferably 8.0 to 8.5.

The SP value is calculated based on the Okitsu method described in Journal of The Adhesion Society of Japan, 29 (3), 1993, 204-211.

It is preferable for Component A to be an elastomer or a plastomer. If Component A is an elastomer or a plastomer, when a printing plate precursor for laser engraving obtained from Component A is shaped into a sheet or a cylinder, it is possible to accomplish excellent thickness accuracy or dimensional accuracy. Moreover, if Component A is an elastomer or a plastomer, it is preferable since a flexographic printing plate can obtain elasticity as required.

In the present invention, the “plastomer” refers to a polymer which is easily fluidized and deformed by heating and can be solidified into a shape formed by deformation by cooling, as described in “Polymer Encyclopedia, New Edition” edited by The Society of Polymer Science, Japan (Japan, Asakura Publishing Co., Ltd., 1988). The “plastomer” is a contrasting term of an “elastomer” (a polymer having properties by which the polymer is deformed instantaneously by an external force when the external force is applied thereto and restores its original shape in a short time when the external force is removed). The plastomer does not undergo elastic deformation unlike the elastomer but easily undergoes plastic deformation.

In the present invention, the plastomer refers to a polymer having properties in which if the original size of the polymer is defined as 100%, the polymer can be deformed up to 200% by a small external force at room temperature (20° C.), and even when the external force is removed, the polymer does not shrink to a size equal to or less than 130% of its original size. The “small external force” specifically refers to an external force that results in a tensile strength of 1 to 100 MPa. More specifically, the plastomer refers to a polymer having properties mentioned below. That is, when a tensile test is performed using a dumbbell test specimen type 4 specified in JIS K 6251-1993 at 20° C. based on the tensile permanent set test of JIS K 6262-1997, the polymer can be stretched by two times the gauge length measured before the tensile test, which has not been subjected to the tensile test, without being ruptured, and after the polymer is kept as is for 60 minutes from the point in time when it is stretched by 2 times the gauge length measured before the tensile test, a degree of tensile permanent set of the polymer becomes at least 30% after 5 minutes elapses from when the application of an external tensile strength is removed. In the present invention, the entire test process is based on the tensile permanent set test method of JIS K 6262-1997, except that the specimen is made into a dumbbell type 4 specified in JIS K 6251-1993; the specimen is kept as is for 60 minutes; and the temperature of the test room is set to 20° C.

A polymer that cannot be measured by the aforementioned method, that is, a polymer which is deformed even if an external tensile strength is not applied thereto and does not restore its original shape in a tensile test or a polymer which is ruptured when the small external force used for the aforementioned measurement is applied thereto corresponds to the plastomer.

Furthermore, in the present invention, the plastomer has a glass transition temperature (Tg) of a polymer of lower than 20° C. In the case of a polymer having at least two kinds of Tg, all of them are lower than 20° C. The Tg of a polymer can be measured by differential scanning calorimetry (DSC).

In the present invention, the elastomer refers to a polymer which could be stretched by two times the gauge length in the above tensile test and exhibits tensile permanent set of less than 30% after 5 minutes elapses from when an external tensile strength is removed.

The viscosity at 20° C. of Component A of the present invention is preferably 10 Pa·s to 10 kPa·s, and more preferably 50 Pa·s to 5 kPa·s. If the viscosity is within the above range, the resin composition is easily formed into a printing plate precursor in the form of a sheet or cylinder, and the process thereof is also simplified. In the present invention, if Component A is a plastomer, when a printing plate precursor for laser engraving obtained from Component A is shaped into a sheet or a cylinder, it is possible to accomplish excellent thickness accuracy or dimensional accuracy.

In the present invention, one kind of Component A may be used on its own, or two or more kinds thereof may be used concurrently.

The total content of Component A in the resin composition for laser engraving of the present invention is preferably 5 to 90 mass %, more preferably 15 to 85 mass %, and yet more preferably 30 to 80 mass %, with respect to a total solid mass content of the resin composition for laser engraving. If the content of Component A is controlled to be equal to or more than 5 mass %, it is possible to obtain printing durability that is sufficient for the obtained flexographic printing plate to be used as a printing plate. If the content is controlled to be equal to or less than 90 mass %, the amount of other components does not become insufficient, and when the resin composition is formed into a flexographic printing plate, it is possible to obtain flexibility that is sufficient for the flexographic printing plate to be used as a printing plate.

Here, the “total solid mass content” refers to a total mass of the resin composition for laser engraving excluding volatile components such as a solvent.

(Component B) Compound Having an Acid Group and an Ethylenically Unsaturated Bond

The resin composition for laser engraving of the present invention contains (Component B) a compound having an acid group and an ethylenically unsaturated bond.

Component B is crosslinked with the internal olefin bond that Component A has and with the ethylenically unsaturated bond that Component A has on the terminal of a main chain or on a side chain.

The number of the ethylenically unsaturated bond in Component B is not particularly limited as long as the number is equal to or greater than 1. From the viewpoint of forming a crosslink, the number is preferably equal to or greater than 2, more preferably 2 to 6, yet more preferably 2 to 4, particularly preferably 2 or 3, and most preferably 2.

Preferable examples of the acid group that Component B has include a carboxy group, a sulfonic acid group, a phosphoric acid group, and a phosphonic acid group. Among these, from the viewpoint of solubility in an organic solvent, a carboxy group, a sulfonic acid group, and a phosphoric acid group are more preferable, and a carboxy group is particularly preferable.

Moreover, these acid groups may form a salt, and examples of the salt include —COOM, —SO₃M, —OPO₃M₂, —OPO₂(OH)M, —PO₃M₂, and —PO₂(OH)M. M may be a monovalent cation or a polyvalent cation.

The number of the acid group that Component B has in a single molecule is preferably 1 to 6, more preferably 1 to 3, yet more preferably 1 or 2, and particularly preferably 1. If the number of acid group that Component B has is within the above range, it is preferable since excellent resistance to various inks is obtained.

The molecular weight of Component B (weight average molecular weight if Component B has a molecular weight distribution) is preferably equal to or smaller than 3,000, more preferably 100 to 2,000, yet more preferably 200 to 1,500, and particularly preferably 300 to 1,000.

The ethylenically unsaturated bond and the acid group in Component B may be directly bonded to each other or may be bonded to each other through a polyvalent organic linking group.

It is preferable for the polyvalent organic linking group to be a group having at least one bond selected from a group consisting of an ester bond, a thioester bond, an amide bond, an ether bond, a thioether bond, a urethane bond, a thiourethane bond, a urea bond, a thiourea bond, and an amino bond (—N(R^{A})—; R^{A} denotes a monovalent organic group). It is more preferable for the polyvalent organic linking group to be a group having a combination selected from combinations of two or more polyvalent hydrocarbon groups and at least one bond selected from a group consisting of an ester bond, a thioester bond, an amide bond, an ether bond, a thioether bond, a urethane bond, a thiourethane bond, a urea bond, a thioureabond, and an amino bond (—N(R^{A})—; R^{A} denotes a monovalent organic group).

Moreover, it is preferable for the polyvalent organic linking group to be a group having at least one urethane bond.

The above polyvalent hydrocarbon group may be one of the polyvalent aliphatic hydrocarbon group, polyvalent aromatic hydrocarbon group, and combination of these. The above polyvalent aliphatic hydrocarbon group may be linear, branched, or cyclic. Furthermore, the above polyvalent aliphatic hydrocarbon group may have a monovalent hydrocarbon group as a substituent.

Component B usable in the present invention is preferably a compound represented by the following Formula (1)

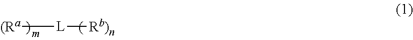

(In Formula (1), R^{a} denotes an ethylenically unsaturated bond, m denotes an integer from 1 to 3, R^{b} denotes an acid group, n denotes 1 or 2, and L denotes a single bond or an (m+n)-valent organic linking group which connects a bonding group and an acid group.)

In Formula (1), R^{a} denotes an ethylenically unsaturated bond, and R^{b} denotes an acid group. The acid group denoted by R^{b} has the same definition as the acid group in Component B described above, and preferable ranges thereof are also the same.

In Formula (1), the number m of R^{a} denotes an integer from 1 to 3. m is preferably 2 or 3, and more preferably 2.

In Formula (1), the number n of R^{b} denotes 1 or 2 and is preferably 1.

In Formula (1), L denotes a single bond or an (m+n)-valent organic linking group and is preferably an (m+n)-valent organic linking group.

It is preferable for the (m+n)-valent organic linking group to be an (m+n)-valent group having at least one bond selected from a group consisting of an ester bond, a thioester bond, an amide bond, an ether bond, a thioether bond, a urethane bond, a thiourethane bond, a urea bond, a thioureabond, and an amino bond (—N(R^{A})—; R^{A} denotes a monovalent organic group). It is more preferable for the (m+n)-valent organic linking group to be an (m+n)-valent group having a combination selected from combinations of two or more polyvalent hydrocarbon groups and at least one bond selected from a group consisting of an ester bond, a thioester bond, an amide bond, an ether bond, a thioether bond, a urethane bond, a thiourethane bond, a urea bond, a thiourea bond, and an amino bond (—N(R^{A})—; R^{A} denotes a monovalent organic group).

Preferable examples of Component B usable in the present invention specifically include the following B1-1 to B1-5. However, needless to say, Component B usable in the present invention is not limited thereto.

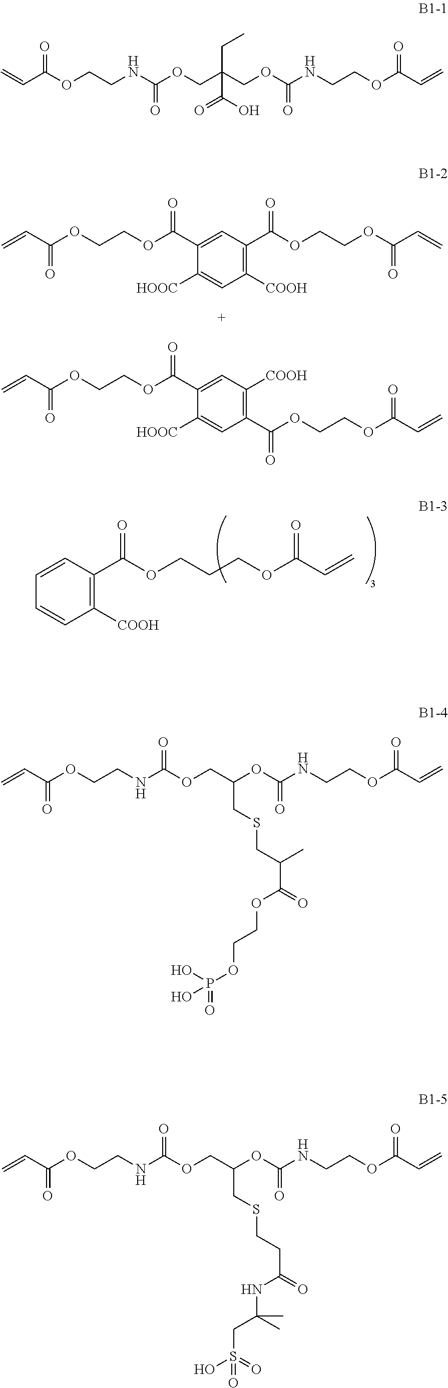

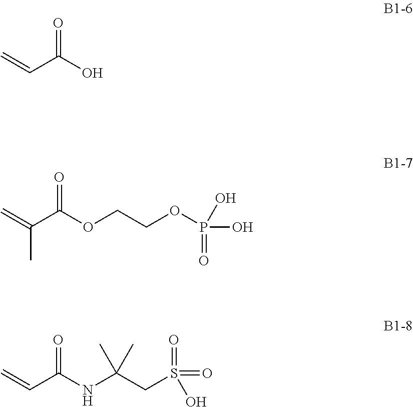

Among these, B1-1 and B1-3 are preferable, and B1-1 is particularly preferable.

In the present invention, one kind of Component B may be used on its own, or two or more kinds thereof may be used concurrently.

In view of balance between film strength and flexibility of film, provided that the total solid mass content is 100 mass %, the amount of Component B added to the resin composition of the present invention is preferably 0.5 to 20 mass %, more preferably 5 to 15 mass %, and particularly preferably 10 to 15 mass %.

Moreover, a ratio (mass ratio) of Component A to Component B used in the resin composition of the present invention is preferably 88.5:0.5 to 69:20 (Component A:Component B) and more preferably 83:6 to 75:14.

(Component C) Polymerization Initiator

The resin composition for laser engraving of the present invention contains (Component C) a polymerization initiator. If the resin composition contains Component C, formation of crosslink between ethylenically unsaturated bonds contained in Component A and Component B is accelerated.

As the polymerization initiator, compounds known to those skilled in the art can be used without particular limitation, and any of the photopolymerization initiator and thermal polymerization initiator can be used. However, it is preferable to use a thermal polymerization initiator since this makes it possible to form crosslink by a simple apparatus. Hereinafter, a radical polymerization initiator as a preferable polymerization initiator will be described in detail, but the present invention is not limited to the description.

In the present invention, preferable polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the flexographic printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds preferably include the following compounds.

### (c) Organic Peroxide

Preferred examples of the (c) organic peroxide as a polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate, t-butylperoxybenzoate, t-butylperoxy-3-methylbenzoate, t-butylperoxylaurate, t-butylperoxypivalate, t-butylperoxy-2-ethylhexanoate, t-butylperoxy-3,5,5-trimethyl hexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropyl monocarbonate, and t-butylperoxy-2-ethylhexylmonocarbonate, and among them peroxyester-based ones are more preferable, and from the viewpoint of excellent compatibility t-butylperoxybenzoate is yet more preferable from the viewpoint of excellent compatibility.

### (l) Azo Compounds

Preferable (l) azo compounds as a polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

It has been found that in the present invention the organic peroxide (c) above is preferable as a polymerization initiator in the present invention from the viewpoint of the crosslinkablility and improvement of engraving sensitivity.

From the viewpoint of engraving sensitivity, combined use of an (c) organic peroxide and (Component D) a photothermal conversion agent, which is described later, in combination is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It will be described in detail in the explanation of photothermal converting agent, the effect thereof is remarkable when carbon black is used as the photothermal converting agent. It is considered that the heat generated from the carbon black is also transmitted to (c) an organic peroxide and, as the result, heat is generated not only from the carbon black but also from the organic peroxide, and that the generation of heat energy to be used for the decomposition of Component A etc. occurs synergistically.

In the present invention, one kind of Component C may be used on its own, or two or more kinds thereof may be used concurrently.

The content of Component C contained in the resin composition for laser engraving of the present invention is preferably 0.01 to 10 mass %, and more preferably 0.1 to 3 mass %, with respect to the total solid mass content. If the content is within the above range, it is preferable since curability (crosslinkability) becomes excellent, the shape of the edge of laser-engraved relief is satisfactory, and further, rinsing properties become excellent.

(Component D) Photothermal Conversion Agent

The resin composition for laser engraving of the present invention preferably further includes (Component D) a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

The photothermal conversion agent in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 mass %, more preferably 0.05 to 20 mass %, and particularly preferably 0.1 to 10 mass %, relative to the total weight of the resin composition.

Various types of Components contained in the resin composition for laser engraving of the present invention other than Components A to D are explained below.

(Component E) Polyfunctional Ethylenically Unsaturated Compound

The resin composition for laser engraving of the present invention may further contain (Component E) a polyfunctional ethylenically unsaturated compound, in addition to Component B. If the resin composition contains Component E, it is preferable since curability of the resin composition becomes excellent, and a flexographic printing plate excellent in printing durability is obtained. Needless to say, compounds corresponding to Component B are not included in (Component E) the polyfunctional ethylenically unsaturated compound. That is, Component E does not contain an acid group.

Moreover, it is preferable for the polyfunctional ethylenically unsaturated compound usable in the present invention to have a molecular weight (or weight average molecular weight) of less than 2,000.

The polyfunctional ethylenically unsaturated compound is a compound having two or more ethylenically unsaturated groups. One kind of the polyfunctional ethylenically unsaturated compound may be used on its own, or two or more kinds thereof may be used concurrently.

Furthermore, a group of compounds belonging to the ethylenically unsaturated compound is widely known in the field of related art, and in the present invention, those compounds can be used without particular limitation. These compounds are in the chemical form such as a monomer, a prepolymer, that is, a dimer, a trimer, and an oligomer, or a copolymer of these, and a mixture of these.

As the polyfunctional ethylenically unsaturated compound, polyfunctional monomers are preferably used. The molecular weight of those polyfunctional monomers (weight average molecular weight when the polyfunctional monomers has molecular weight distribution) is preferably equal to or higher than 200 but less than 2,000, more preferably 200 to 1,000, and yet more preferably 200 to 700.

As the polyfunctional monomer, compounds having 2 to 20 terminal ethylenically unsaturated groups are preferable.

Examples of compounds from which the ethylenically unsaturated group in the polyfunctional ethylenically unsaturated compound is derived include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group or an amino group with polyfunctional isocyanates or epoxides, and dehydrating condensation reaction products with a polyfunctional carboxylic acid, etc. are also used favorably. Moreover, addition reaction products of unsaturated carboxylic acid esters or amides having an electrophilic substituent such as an isocyanato group or an epoxy group with monofunctional or polyfunctional alcohols or amines, and substitution reaction products of unsaturated carboxylic acid esters or amides having a leaving group such as a halogen group or a tosyloxy group with monofunctional or polyfunctional alcohols or amines are also favorable. Moreover, as another example, the use of compounds obtained by replacing the unsaturated carboxylic acid with a vinyl compound, an allyl compound, an unsaturated phosphonic acid, styrene or the like is also possible.

From the viewpoint of the reactivity, the ethylenically unsaturated group contained in the polyfunctional monomer is preferably a residue of each of acrylates, methacrylates, vinyl compounds and allyl compounds, and more preferably a residue of acrylates and methacrylates.

Specific examples of ester monomers of an aliphatic polyhydric alcohol compound and an unsaturated carboxylic acid include acrylic acid esters such as ethylene glycol diacrylate, diethylene glycol diacrylate, triethylene glycol diacrylate, polyethylene glycol diacrylate, 1,3-butanediol diacrylate, tetramethylene glycol diacrylate, propylene glycol diacrylate, dipropylene glycol diacrylate, triypropylene glycol diacrylate, porypropylene glycol diacrylate, neopentyl glycol diacrylate, hexanediol diacrylate, 1,4-cyclohexanediol diacrylate, tetraethylene glycol diacrylate, polytetramethylene glycol diacrylate, 1,8-octandiol deacrylate, 1,9-nonaldiol diacrylate, 1,10-decandiol diacrylate, trycyclodecandimetanol diacrllate, trimethylole propane triacrilate, trimethylole propane tri(acryloiloxypropyl)ether, ditrimethylol propane tetraacrylate, trimethyloleethane tetraacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Examples of methacrylic acid esters include tetramethylene glycol dimethacrylate, ethyleneglycol dimethacrylate, diethyeneglycol dimethacrylate, triethylene glycol dimethacrylate, polyethylene glycol dimethacrylate. neopentyl glycol dimethacrylate, trimethylolpropane trimethacrylate, trimethylolethane trimethacrylate, ethylene glycol dimethacrylate, diethylene glycol dimethacrylate, 1,3-butanediol dimethacrylate, 1,6-hexanediol dimethacrylate, 1,8-hexandiol dimethacrylate, 1,9-nonandiol dimethacrylate, 1,10-decandiol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane. Among these, trimethylolepropane trimethacrylate and polyethylene glycol dimethacrylate are preferable.

As examples of other esters, for example, aliphatic alcohol-based esters described in JP-B-46-27926 (JP-B denotes a Japanese examined patent application publication), JP-B-51-47334, and JP-A-57-196231, those having an aromatic skeleton described in JP-A-59-5240, JP-A-59-5241, and JP-A-2-226149, and those containing an amino group described in JP-A-1-165613 may suitably be used.

The above-mentioned ester-based monomer may be used on their own or as a mixture of two or more types thereof.

Specific examples of an amide monomer from an aliphatic polyvalent amine compound and an unsaturated carboxylic acid include methylene bis(meth)acrylamide, 1,6-hexamethylene bis(meth)acrylamide, diethylenetriamine tris(meth)acrylamide, and xylylene bis(meth)acrylamide.

Examples of other preferred amide-based monomer include those having a cyclohexylene structure described in JP-B-54-21726.

Furthermore, as a polyfunctional ethylenically unsaturated compound, a urethane-based addition-polymerizable polyfunctional compound produced by an addition reaction of an isocyanate and a hydroxy group is also suitable. Specific examples thereof include a vinyl urethane compound containing two or more polymerizable vinyl groups per molecule in which a polyisocyanate compound having two or more isocyanato groups per molecule described in JP-B-48-41708 is added to a hydroxy group-containing vinyl monomer represented by Formula (i) below.

CH₂═C(R)COOCH₂CH(R)OH (i)

(R and R′ independently denote H or CH₃.)

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, and JP-B-62-39418 are also suitable.

Furthermore, by use of addition-polymerizable compounds having an amino structure in the molecule described in JP-A-63-277653, JP-A-63-260909, and JP-A-1-105238, a resin composition for laser engraving which can crosslink in a short time can be obtained.

Other examples of the polyfunctional ethylenically unsaturated compound include polyester acrylates such as those described in JP-A-48-64183, JP-B-49-43191, and JP-B-52-30490, and polyfunctional acrylates and methacrylates such as epoxy acrylates etc. formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Among these, Component E is preferably acrylate (acrylic acid ester compound) or methacrylate (methacrylic acid ester compound). Particularly, Component E is preferably an ester of a compound consisting of an aliphatic polyol with acrylic acid or methacrylic acid. Component E preferably has 2 to 20 (meth)acryloyloxy groups in a single molecule, more preferably has 2 to 8 (meth)acryloyloxy groups in a single molecule, yet more preferably has 2 to 6 (meth)acryloyloxy groups in a single molecule, and particularly preferably has 2 to 4 (meth)acryloyloxy groups in a single molecule.

Among these, it is preferable for Component E to contain at least one compound selected from a group consisting of hexanediol diacrylate, 1,10-decanediol diacrylate, tricyclodecane dimethanol diacrylate, pentaerythritol tetraacrylate, and dipentaerythritol hexaacrylate.

It is preferable for the content of Component E to be equal to or smaller than the content of Component B. That is, provided that a total amount of Component E and Component B is 100 mass %, the content of Component E is preferably equal to or smaller than 50 mass %, more preferably equal to or smaller than 25 mass %, and yet more preferably equal to or smaller than 10 mass %.

(Component F) Monofunctional Ethylenically Unsaturated Compound

The resin composition for laser engraving of the present invention may contain (Component F) a monofunctional ethylenically unsaturated compound. Needless to say, compounds corresponding to Component B are not included in Component F. That is, Component F does not contain an acid group.

Examples of monofunctional polymerizable compounds having only one ethylenically unsaturated group include esters of unsaturated carboxylic acids such as itaconic acid, crotonic acid, isocrotonic acid, and maleic acid, amides, acid anhydrides having an ethylenically unsaturated group, (meth)acrylates, (meth)acrylamides, (meth)acrylonitriles, and styrenes, and further include various polymerizable compounds such as unsaturated polyester resins, unsaturated polyether resins, unsaturated polyamide resins, and unsaturated urethane resins.

Furthermore, a product of an addition reaction between an unsaturated carboxylic acid ester or amides, which has a nucleophilic substituent such as a hydroxyl group, an amino group, or a mercapto group, and an isocyanates or epoxies, a product of a dehydration condensation reaction between the unsaturated carboxylic acid ester or amides and monofunctional or polyfunctional carboxylic acid, and the like are suitably used.

Furthermore, addition reaction products of an unsaturated carboxylic acid ester or amide having an electrophilic substituent such as an isocyanato group or an epoxy group, and an alcohol, an amine or a thiol, and substitution reaction products of an unsaturated carboxylic acid ester or amide having a detachable substituent such as a halogeno group or a tosyloxy group, and an alcohol, an amine or a thiol, are also suitable.

Also, as other examples, a group of compounds substituted with unsaturated phosphonic acid, styrene, vinyl ether or the like instead of the unsaturated carboxylic acid described above, can also be used.

The polymerizable compound is not particularly limited, and various known compounds can be used in addition to the compounds exemplified above. For example, those compounds described in JP-A-2009-204962 and the like may also be used.

Furthermore, preferred examples of the monofunctional polymerizable compound used include (meth)acrylic acid derivatives such as methyl(meth)acrylate, ethyl(meth)acrylate, n-butyl(meth)acrylate, 2-ethylhexyl(meth)acrylate, 2-hydroxyethyl(meth)acrylate, butoxyethyl(meth)acrylate, carbitol (meth)acrylate, cyclohexyl(meth)acrylate, benzyl(meth)acrylate, N-methylol(meth)acrylamide, and epoxy(meth)acrylate, N-vinyl compounds such as N-vinylpyrrolidone and N-vinylcaprolactam, and allyl compounds such as allyl glycidyl ether, diallyl phthalate, and triallyl trimellitate. Among these, trimethylolepropane trimethacrylate and polyethylene glycol dimethacrylate are preferable.

Among them, the monofunctional polymerizable compound is preferably monofunctional (meth)acrylate compound (monofunctional (meth)acrylic ester).

In the present invention, for the resin composition for laser engraving, one kind of Component F may be used on its own, or two or more kinds thereof may be used concurrently.

From the viewpoint of flexibility or brittleness of the crosslinked film, the total content of (Component F) the monofunctional ethylenically unsaturated compound in the resin composition for laser engraving of the present invention is preferably within a range from 0.1 to 40 mass %, and more preferably within a range from 1 to 20 mass %, with respect to the total solid mass content of the resin composition. It is preferable for the content of Component F to be equal to or smaller than the content of Component B. That is, provided that the total amount of Component F and Component B is 100 mass %, the content of Component F is preferably equal to or smaller than 50 mass %, more preferably equal to or smaller than 25 mass %, and yet more preferably equal to or smaller than 10 mass %.

### <Plasticizer>

The resin composition for laser engraving of the present invention may comprise a plasticizer.

A plasticizer has the function of softening a film formed from the resin composition for laser engraving, and it is necessary for it to be compatible with a binder polymer.

Preferred examples of the plasticizer include dioctyl phthalate, didodecyl phthalate, bisbutoxyethyl adipate, a polyethylene glycol, and a polypropylene glycol (monool type or diol type).

Among them, bisbutoxyethyl adipate is particularly preferable.

With regard to the plasticizer in the resin composition of the present invention, one type thereof may be used on its own or two or more types may be used in combination.

### <Solvent>

It is preferably to use a solvent when preparing the resin composition for laser engraving of the present invention.

As the solvent, an organic solvent is preferably used.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

### <Other Additives>

The resin composition for laser engraving of the present invention may comprise as appropriate various types of known additives as long as the effects of the present invention are not inhibited. Examples include a filler, a wax, a process oil, an a metal oxide, an antiozonant, an anti-aging agent, a thermopolymerization inhibitor, and a colorant, and one type thereof may be used on its own or two more types may be used in combination.

(Flexographic Printing Plate Precursor for Laser Engraving)

A first embodiment of the flexographic printing plate precursor for laser engraving of the present invention has a relief-forming layer formed of the resin composition for laser engraving of the present invention.

A second embodiment of the flexographic printing plate precursor for laser engraving of the present invention has a crosslinked relief-forming layer obtained by crosslinking the relief-forming layer formed of the resin composition for laser engraving of the present invention.

In the present invention, the “flexographic printing plate precursor for laser engraving” refers to either or both of a precursor in which the relief-forming layer, which is formed of the resin composition for laser engraving and exhibits crosslinkability, has not undergone crosslinking and a precursor in which the relief-forming layer has been cured by light and/or heat.

In the present invention, the “relief-forming layer” refers to a layer having not undergone crosslinking. That is, the relief-forming layer is a layer formed of the resin composition for laser engraving of the present invention, and if necessary, the layer may be dried.

In the present invention, the “crosslinked relief-forming layer” refers to a layer obtained by crosslinking the above relief-forming layer. It is preferable for the crosslinking to be performed by heat and/or light. The crosslinking is not particularly limited as long as it is a reaction by which the resin composition is cured. Although the crosslinking is a term having the concept including a crosslinked structure formed by a reaction between Component A and Component B or a reaction between Components B, it is preferable that a crosslinked structure be formed by a reaction between Component A and Component B.

By laser-engraving the printing plate precursor having the crosslinked relief-forming layer, the “flexographic printing plate” is prepared.

In the present invention, the “relief layer” refers to a laser-engraved layer in the flexographic printing plate, that is, the crosslinked relief-forming layer having undergone laser engraving.

The relief-forming layer is preferably provided above a support.

The flexographic printing plate precursor for laser engraving may further comprise, as necessary, an adhesive layer between the support and the relief-forming layer and, above the relief-forming layer, a slip coat layer and a protection film.

### <Relief-Forming Layer>

The relief-forming layer is a layer formed from the resin composition for laser engraving of the present invention, and is preferably a layer that is cured by at least one of light and heat, that is, a layer having crosslinkablility.

As a process for producing a flexographic printing plate using the flexographic printing plate precursor of the present invention, it is preferably a process for producing a flexographic printing plate by crosslinking a relief-forming layer and then carrying out laser engraving to thus form a relief layer. By crosslinking the relief-forming layer, it is possible to prevent abrasion of the relief layer during printing, and it is possible to obtain a flexographic printing plate having a relief layer with a sharp shape after laser engraving.

In addition, the relief-forming layer may be formed by molding the resin composition for laser engraving into a sheet shape or a sleeve shape.

### <Support>

The support that can be used in the flexographic printing plate precursor for laser engraving is now explained.

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET) or polybutylene terephthalate (PBT)), polyacrylonitrile (PAN) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

Furthermore, in a flexographic printing plate precursor for laser engraving prepared by coating a crosslinkable resin composition for laser engraving and curing it from the reverse face (face opposite to the face that is to be subjected to laser engraving, those with a cylindrical shape also being included) by means of heat and/or light, the reverse face of the cured resin composition for laser engraving functions as a support, and a support is therefore not always necessary.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

The process for producing a flexographic printing plate precursor for laser engraving is now explained.

Formation of a relief-forming layer in the flexographic printing plate precursor for laser engraving is not particularly limited, and examples thereof include a method in which the resin composition for laser engraving is prepared, solvent is removed from this coating solution composition for laser engraving, and it is melt-extruded onto a support. Alternatively, a method may be employed in which the coating solution composition for laser engraving is cast onto a support, and this is dried in an oven to thus remove solvent from the coating solution composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming a relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove the solvent.

The resin composition for laser engraving may be produced by, for example, dissolving Component A, Component B and as optional components a photothermal conversion agent, a plasticizer and a fragrance in an appropriate solvent, and then dissolving Component C. Since it is necessary to remove most of the solvent component in a stage of producing a flexographic printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the relief-forming layer in the flexographic printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

### <Crosslinking Step>

The process for producing a flexographic printing plate precursor for laser engraving of the present invention is preferably a production process comprising a crosslinking step of crosslinking the relief-forming layer by means of heat and/or light to thus obtain a flexographic printing plate precursor having a crosslinked relief-forming layer.

With regard to irradiation with light, it is preferable to carry it out for the entire surface of the relief-forming layer.

Examples of the light include visible light, UV light, and an electron beam, and UV light is most preferable. When the support side of the relief-forming layer is defined as the reverse face, only the front face need be irradiated with light, but when the support is a transparent film through which light passes, it is preferable to further irradiate the reverse face with light as well. When a protection film is present, irradiation from the front face may be carried out with the protection film as it is or after peeling off the protection film. When there is a possibility of a crosslinking reaction being inhibited in the presence of oxygen, irradiation with light may be carried out after superimposing a polyvinyl chloride sheet on the relief-forming layer and evacuating.

When the relief-forming layer comprises a thermopolymerization initiator (the above-mentioned photopolymerization initiator being capable of functioning also as a thermopolymerization initiator), the relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or an infrared oven for a predetermined period of time and a method in which it is put into contact with a heated roller for a predetermined period of time.

As a method for crosslinking the relief-forming layer in the crosslinking step, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, the tackiness of engraving residue formed when laser engraving is suppressed.

(Flexographic Printing Plate and Process for Making the Plate)

The process for making a flexographic printing plate of the present invention includes steps of preparing the flexographic printing plate precursor for laser engraving of the present invention, and laser-engraving a flexographic printing plate precursor having the crosslinked relief-forming layer.

It is preferable for the step of preparing to include steps of forming a relief-forming layer formed of the resin composition for laser engraving of the present invention, and crosslinking the relief-forming layer by heat and/or light so as to obtain a flexographic printing plate precursor having a crosslinked relief-forming layer.

The flexographic printing plate of the present invention is a flexographic printing plate having a relief layer that is obtained by crosslinking and laser-engraving a layer formed of the resin composition for laser engraving of the present invention. It is preferable for the flexographic printing plate to be made by the process for making a flexographic printing plate of the present invention.

The step of forming a relief-forming layer and the step of crosslinking in the process for making a flexographic printing plate of the present invention have the same definition as the step of forming a relief-forming layer and the step of crosslinking in the above described process for producing a flexographic printing plate precursor for laser engraving, and preferable ranges thereof are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser or a semiconductor laser is preferable. In particular, a fiber-coupled semiconductor infrared laser is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm may be used, but one having a wavelength of 800 to 1,200 nm is preferable, one having a wavelength of 860 to 1,200 nm is more preferable, and one having a wavelength of 900 to 1,100 nm is particularly preferable.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

When engraving residue is attached to the engraved surface, a rinsing step of washing off engraving residue by rinsing the engraved surface with water or a liquid containing water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

### <Rinsing Liquid>

As the rinsing liquid usable in the present invention, water or an aqueous rinsing liquid containing water as a main component is preferable. The aqueous rinsing liquid refers to a rinsing liquid containing water as a main component. Examples of the water include tap water, deionized water, pure water, and the like. Among these, deionized water is preferably used.

pH of the rinsing liquid is preferably equal to or higher than 8, more preferably equal to or higher than 9, and yet more preferably equal to or higher than 10. Moreover, the pH is preferably equal to or lower than 13.5, more preferably equal to or lower than 13.0, and yet more preferably equal to or lower than 12.5. If the pH is within the above range, sufficient rinsing properties (washing performance) are obtained, and it is easy to handle such a rinsing liquid.

In order to regulate pH of the rinsing liquid to fall within the above range, an acid and a base may be appropriately used for pH regulation. The acid and base to be used are not particularly limited.

As the base (basic compound), known basic compounds can be used without particular limitation, but an inorganic basic compound is preferable; an alkali metal salt compound and an alkaline earth metal salt compound are more preferable; and an alkali metal hydroxide is yet more preferable.

Examples of the basic compound include inorganic alkali salts such as sodium hydroxide, ammonium hydroxide, potassium hydroxide, lithium hydroxide, sodium silicate, potassium silicate, tribasic sodium phosphate, tribasic potassium phosphate, tribasic ammonium phosphate, dibasic sodium phosphate, dibasic potassium phosphate, dibasic ammonium phosphate, sodium carbonate, potassium carbonate, ammonium carbonate, sodium hydrogen carbonate, potassium hydrogen carbonate, ammonium hydrogen carbonate, sodium borate, potassium borate, and ammonium borate.

When an acid is used for pH regulation, an inorganic acid is preferable, and examples thereof include hydrochloric acid, sulfuric acid, phosphoric acid, and nitric acid.

The rinsing liquid preferably comprises a surfactant.

The surfactant is not particularly limited; a known surfactant may be used, and examples thereof include an anionic surfactant, a cationic surfactant, an amphoteric surfactant, and a nonionic surfactant.

Examples of the anionic surfactant include a fatty acid salt, an abietate, a hydroxyalkanesulfonate, an alkanesulfonate, an □-olefinsulfonate, a dialkylsulfosuccinate, an alkyl diphenyl ether disulfonate, a straight chain alkylbenzenesulfonate, a branched chain alkylbenzenesulfonate, an alkylnaphthalenesulfonate, an alkylphenoxypolyoxyethylenepropylsulfonate, a polyoxyethylene alkyl sulfophenyl ether, a sodium N-methyl-N-oleyltaurate, an N-alkylsulfosuccinic acid monoamide disodium salt, a petroleum sulfonate, sulfated castor oil, sulfated tallow oil, a fatty acid alkyl ester sulfate ester salt, an alkylsulfate ester salt, a polyoxyethylene alkyl ether sulfate ester salt, a fatty acid monoglyceride sulfate ester salt, a polyoxyethylene alkyl phenyl ether sulfate ester salt, a polyoxyethylene styryl phenyl ether sulfate ester salt, an alkylphosphate ester salt, a polyoxyethylene alkyl ether phosphate ester salt, a polyoxyethylene alkyl phenyl ether phosphate ester salt, a partially saponified styrene-maleic anhydride copolymer, a partially saponified olefin-maleic anhydride copolymer, and a naphthalenesulfonate formalin condensate.

Examples of the cationic surfactant include an alkylamine salt and a quaternary ammonium salt.

Examples of the amphoteric surfactant include an alkylcarboxybetaine, an alkylimidazoline, and an alkylaminocarboxylic acid.

Examples of the nonionic surfactant include a polyoxyethylene alkyl ether, a polyoxyethylene alkyl phenyl ether, polyoxyethylene polystyryl phenyl ether, polyoxyethylene polyoxypropylene alkyl ether, a glycerol fatty acid partial ester, a sorbitan fatty acid partial ester, a pentaerythritol fatty acid partial ester, propylene glycol monofatty acid ester, sucrose fatty acid partial ester, a polyoxyethylene sorbitan fatty acid partial ester, a polyoxyethylene sorbitol fatty acid partial ester, a polyethylene glycol fatty acid ester, a polyglycerol fatty acid partial ester, a fatty acid diethanolamide, an N,N-bis-2-hydroxyalkylamine, polyoxyethylene alkylamine, triethanolamine fatty acid ester, trialkylamine oxide, polypropylene glycol having a molecular weight of 200 to 5,000, trimethylolpropane, a glycerol or sorbitol polyoxyethylene or polyoxypropylene adduct, and an acetylene glycol series surfactant.

Furthermore, the surfactant that can be used in the present invention is preferably a carboxybetaine compound, a sulfobetaine compound, a phosphobetaine compound, an amine oxide compound, or a phosphine oxide compound.

Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total weight of the rinsing liquid, and more preferably 0.05 to 10 mass %.

The rinsing liquid may comprise an antifoaming agent.

As the antifoaming agent, a compound such as a usual silicone-based self-emuslifying type or emulsifying type, or a nonionic surfactant having an HLB (Hydrophile-Lipophile Balance) value of no greater than 5 may be used. A silicone antifoaming agent is preferable. Among them, any of an emulsion-dispersing type, a solubilization type, etc. may be used.

Specific examples of the antifoaming agent include TSA731 and TSA739 (both from Dow Corning Toray).

The content of the antifoaming agent is preferably 0.001 to 1.0 mass % of the rinsing liquid for flexographic printing plate making.

The flexographic printing plate of the present invention having a relief layer may be produced as described above.

From the viewpoint of satisfying suitability for various aspects of flexographic printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 0.3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

A flexographic printing plate produced by the process for producing a flexographic printing plate of the present invention can be applied to printing by a letterpress printer using an oil-based ink or a UV ink as well as printing by a flexographic printer using a UV ink.

In accordance with the present invention, there can be provided a resin composition for laser engraving that can give an excellent flexographic printing plate having high rinsing properties for engraving residue generated at the time of laser engraving and high ink resistance, a flexographic printing plate precursor and a process for producing same using the resin composition for laser engraving, a process for making a flexographic printing plate using the flexographic printing plate precursor, and a flexographic printing plate obtained thereby.

### EXAMPLES

The present invention is explained in further detail below by reference to Examples, but the present invention should not be construed as being limited to the Examples.

The weight-average molecular weight (Mw) and number-average molecular weight (Mn) of polymers in the Examples mean a value measured by a gel permeation chromatography (GPC) method unless otherwise specified.

The following components were used in examples and comparative examples.

### (Component A)

A1-1: LBR-305 (Kuraprene LBR-305, liquid polybutadiene, manufactured by KURARAY CO., LTD., Mn: 28,100, plastomer)

A1-2: BR150L (UBEPOL BR150L, polybutadiene, manufactured by UBE INDUSTRIES, LTD., Mw: 510,200, plastomer)

A1-3: BR1220 (Nipol BR1220, polybutadiene, manufactured by ZEON CORPORATION, Mw: 483,300, plastomer)

A1-4: R-45HT (Poly bd R-45HT, liquid polybutadiene having hydroxyl group on terminal, manufactured by Idemitsu Kosan Co., Ltd., Mw: 11,900, plastomer)

A1-5: LIR-290 (Kuraprene LIR-290, partially hydrogenated liquid polyisoprene, manufactured by KURARAY CO., LTD., Mw: 31,000, plastomer)

A1-6: DENAREX R-45EPT (polybutadiene diglycidyl ether, manufactured by Nagase ChemteX Corporation., Mw: 12,200, plastomer)

A1-7: Kraton D1102BT (styrene-butadiene-styrene block copolymer (SBS), manufactured by Kraton Performance Polymers Inc., Mw: 110,000, thermoplastic elastomer)

A1-8: Kraton D1161 (styrene-isoprene-styrene triblock copolymer (SIS), manufactured by Kraton Performance Polymers Inc., Mw: 190,000, thermoplastic elastomer)

A1-9: IR2200 (isoprene rubber (polyisoprene), manufactured by JSR Corporation., Mw: 1,550,000, thermoplastic elastomer)

A2-1: UV-3000B (SHIKOH UV-3000B, urethane acrylate, manufactured by Nippon Synthetic Chemical Industry Co., Ltd., Mw: 18,000, plastomer)

A2-2: Resin I (resin obtained by the following Synthesis Example 1, plastomer)

A2-3: Resin II (resin obtained by the following Synthesis Example 2, plastomer)<

### Synthesis Example 1

### Synthesis of Resin I

250 g of polytetramethylene glycol (Mn: 1,830, OH value: 61.3 mgKOH/g) (manufactured by Asahi Kasei Chemicals Corporation.) and 26.2 g of tolylene diisocyanate (manufactured by Wako Pure Chemical Industries, Ltd.) were put into a separable flask equipped with a thermometer, a stirrer, and a reflux tube, and reacted for 3 hours at 60° C. Thereafter, 12.62 g of 2-hydroxypropyl methacrylate (manufactured by Wako Pure Chemical Industries, Ltd.) and 15.9 g of polypropylene glycol monomethacrylate (manufactured by Wako Pure Chemical Industries, Ltd.) were added thereto and reacted for 2 hours, thereby obtaining Resin I having a methacryloyl group as the terminal thereof (the number of polymerizable unsaturated group contained in a single molecule is about 2 on average) and a weight average molecular weight of about 38,000. The structure of Resin I was identified by ¹H-NM R and IR spectroscopy.

### Synthesis Example 2

### Synthesis of Resin II

0.02 g of dibutyltin dilaurate (manufactured by Wako Pure Chemical Industries, Ltd.) was added to 500 g of polyoxyethylene-oxypropylene block copolymer diol (OH value: 44 mgKOH/g, oxyethylene content: 30 mass %), and the resultant was mixed at 40° C. until it became a uniform mixture.

37.3 g of tolylene diisocyanate (manufactured by Wako Pure Chemical Industries, Ltd.) was added to the mixture and uniformly dissolved. Subsequently, the temperature of the resultant was increased to 80° C., and the resultant was reacted for 4 hours, thereby synthesizing a polymer precursor having an isocyanate group on each of both terminals.

34.3 g of poly(oxypropylene) glycol monomethacrylate (manufactured by Wako Pure Chemical Industries, Ltd.) and 17.3 g of hydroxypropyl methacrylate (manufactured by NOF CORPORATION.) were added to the polymer precursor, and the resultant was reacted for 2 hours, thereby obtaining Resin II. The structure of Resin II was identified by ¹H-NMR and IR spectroscopy. The weight average molecular weight of Resin II measured by GPC was 33,000.

### (Component B)

B1-1 to B1-8 and B2-1: compounds represented by the following structure

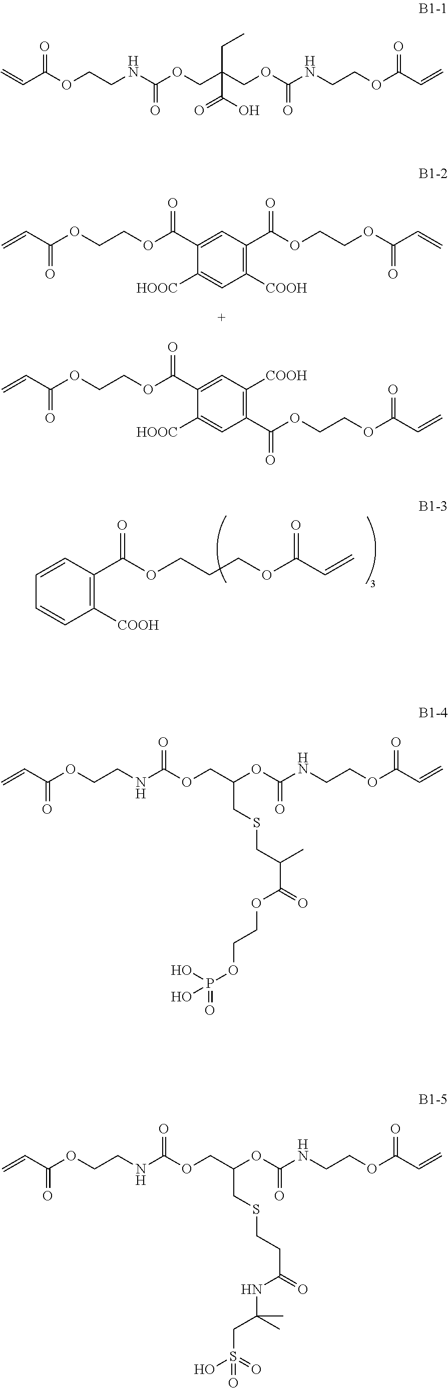

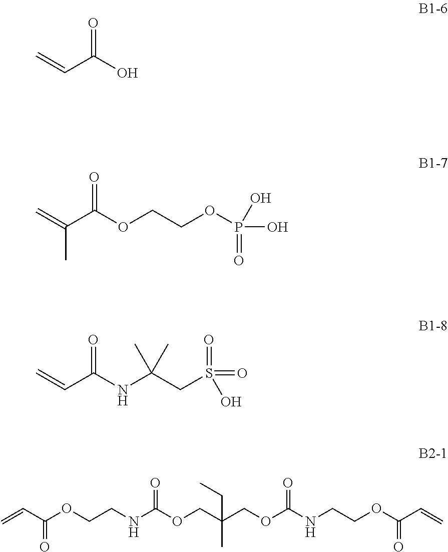

B2-2: HDDA (1,6-hexanediol diacrylate, manufactured by SHIN-NAKAMURA CHEMICAL CO., LTD.)

B2-3: TEGDMA (triethylene glycol dimethacrylate, manufactured by Tokyo Chemical Industry Co., Ltd.)<

### Synthesis Example 3

### Synthesis of B1-1

15 g of DMBA (2,2-bis(hydroxymethyl)butyric acid, manufactured by Wako Pure Chemical Industries, Ltd.) was dissolved in 50 g of THF (tetrahydrofuran, manufactured by Wako Pure Chemical Industries, Ltd.). Thereafter, 15.7 g of Karenz A01 (2-acryloyloxyethyl isocyanate, manufactured by SHOWA DENKO K.K.) was added to and dissolved in the resultant. After Karenz A01 was uniformly dissolved, 0.3 g of butyl tin dilaurate was added thereto, and the resultant was reacted for 5 hours at 70° C. The structure of the resultant was identified by ¹H-NMR and IR spectroscopy.

### Synthesis Example 4

### Synthesis of B1-2

4.36 g (20 mmol) of pyromellitic dianhydride, 15 ml of dried γ-butyrolactone, and pyridine in a catalytic amount were put into and stirred in an eggplant-shaped flask. 5.35 ml (44 mmol, 5.73 g) of 2-hydroxyethyl acrylate was then added thereto, and the resultant was stirred for 16 hours at room temperature under nitrogen gas flow. Thereafter, the reaction solution was added dropwise to a substance which was obtained by adding table salt in an appropriate amount to 2 L of 0.1 N hydrochloric acid, and the precipitates were filtrated and then dried, thereby obtaining 9.5 g of white solids (mixture of isomers described above).

### Synthesis Example 5

### Synthesis of B1-3

B1-3 was synthesized by a general method of reacting a hydroxyl group with an acid anhydride. Specifically, succinic anhydride was added to pentaerythritol triacrylate, thereby preparing B1-3.

### Synthesis Example 6

### Synthesis of B1-4

15 g of thioglycerol (manufactured by Tokyo Chemical Industry Co., Ltd.) was dissolved in 50 g of THF (manufactured by Wako Pure Chemical Industries, Ltd.). Thereafter, 29.1 g of Phosmer M (2-(methacryloyloxy)ethyl phosphate, manufactured by Uni-Chemical Co., Ltd.) was added thereto, and the resultant was cooled to 0° C. Subsequently, 0.8 g of diazabicycloundecene (manufactured by Wako Pure Chemical Industries, Ltd.) was added thereto, and the resultant was reacted for 5 hours at a dark place. Next, the resultant was diluted with distilled water (200 g) added thereto, and then extraction was performed by adding 250 g of diethyl ether (manufactured by Wako Pure Chemical Industries, Ltd.) to the resultant. Thereafter, the resultant was dried over MgSO₄ so as to remove the solvent, thereby obtaining an intermediate. The structure of the intermediate was identified by ¹H-NMR and IR spectroscopy.

15 g of the obtained intermediate was dissolved in THF, 10.8 g of Karenz A01 (manufactured by SHOWA DENKO K.K.) was added to and uniformly dissolved in the resultant under ice cooling. Thereafter, 0.1 g of dibutyltin dilaurate (manufactured by Wako Pure Chemical Industries, Ltd.) was added thereto, and the resultant was reacted for 4 hours at 50° C., thereby obtaining B1-4.

### Synthesis Example 7

### Synthesis of B1-5

15 g of thioglycerol (manufactured by Tokyo Chemical Industry Co., Ltd.) was dissolved in 50 g of THF (manufactured by Wako Pure Chemical Industries, Ltd.). Thereafter, 28.7 g of 2-acrylamide-2-methylpropane sulfonic acid (manufactured by Tokyo Chemical Industry Co., Ltd.) was added thereto, and the resultant was cooled to 0° C. Subsequently, 0.8 g of diazabicycloundecene (manufactured by Wako Pure Chemical Industries, Ltd.) was added thereto, and the resultant was reacted for 5 hours at a dark place. Next, the resultant was diluted with distilled water (200 g) added thereto, and then extraction was performed by adding 250 g of diethyl ether (manufactured by Wako Pure Chemical Industries, Ltd.) to the resultant. Thereafter, the resultant was dried over MgSO₄ so as to remove the solvent, thereby obtaining an intermediate. The structure of the intermediate was identified by ¹H-NMR and IR spectroscopy.

15 g of the obtained intermediate was dissolved in THF, 10.8 g of Karenz A01 (manufactured by SHOWA DENKO K.K.) was added to and uniformly dissolved in the resultant under ice cooling. Thereafter, 0.1 g of dibutyltin dilaurate (manufactured by Wako Pure Chemical Industries, Ltd.) was added thereto, and the resultant was reacted for 4 hours at 50° C., thereby obtaining B1-5.

### Synthesis Example 8

### Synthesis of B2-1

15 g of 2-ethyl-2-methyl-1,3-propanediol (manufactured by Tokyo Chemical Industry Co., Ltd.) was dissolved in 50 g of THF (tetrahydrofuran, manufactured by Wako Pure Chemical Industries, Ltd.). Thereafter, 15.1 g of Karenz A01 (2-acryloyloxyethyl isocyanate, manufactured by SHOWA DENKO K.K.) was added to and dissolved in the resultant. After Karenz AO was uniformly dissolved, 0.3 g of butyltin dilaurate was added thereto, and the resultant was reacted for 5 hours at 70° C. The structure of the resultant was identified by ¹H-NMR and IR spectroscopy.

### (Component C)

Perbutyl Z (t-butyl peroxybenzoate, manufactured by NOF CORPORATION.)

### (Component D)

Carbon black #45 (manufactured by Mitsubishi Chemical Corporation, particle diameter (arithmetic mean diameter): 24 nm, specific surface area (specific surface area calculated by S-BET formula from amount of nitrogen adsorbed, JIS K 6217): 12.5 m²/g, DBP oil absorption amount: 45 cm³/100 g)

### 1. Preparation of Resin Composition for Laser Engraving

Component A described in Tables 1 to 3 that was in the amount expressed in terms of part by mass in Tables 1 to 3, Component B described in Tables 1 to 3 that was in the amount expressed in terms of part by mass in Tables 1 to 3, 1 part by mass of Perbutyl Z as Component C, and 10 parts by mass of Carbon black #45 as Component D were put into a three-neck flask equipped with a stirring blade and a cooling tube. The mixed solution was then heated for 30 minutes at 70° C. under stirring.

### 2. Preparation of Flexographic Printing Plate Precursor for Laser Engraving

A spacer (frame) having a predetermined thickness was placed on a PET substrate. Thereafter, each of the resin compositions for laser engraving of Examples 1 to 72 and Comparative Examples 1 to 57 obtained as above was gently cast such that it did not overflow from the spacer (frame), and heated in an oven at 120° C. so as to provide a relief-forming layer having a thickness of about 1 mm. In this manner, flexographic printing plate precursors for laser engraving were prepared respectively. At this time, heating was performed in the oven at 120° C. until surface tackiness completely disappeared, such that thermal crosslinking occurred.

### 3. Preparation of Flexographic Printing Plate

The crosslinked relief-forming layer having undergone crosslinking was engraved using a carbon dioxide laser (CO₂ laser) or a fiber-coupled semiconductor laser, thereby obtaining a flexographic printing plate.

As the carbon dioxide laser engraving machine, a CO₂ laser engraving machine (manufactured by Comtecs co., ltd, Adflex 250) was used. In the obtained flexographic printing plate precursor for laser engraving, 1 to 10% of halftone dots were formed by the carbon dioxide laser engraving machine, under conditios of an output of 12 W, a head speed of 200 mm/sec, and a pitch setting of 2,400 DPI.

As the semiconductor laser engraving machine, a laser recording device equipped with a fiber-coupled semiconductor laser (FC-LD) SDL-6390 (manufactured by JDS Uniphase Corporation, wavelength of 915 nm) with a maximum output of 8.0 W was used. By using the semiconductor laser engraving machine, 1 to 10% of halftone dots were formed under conditions of a laser output of 7.5 W, a head speed of 409 mm/sec, and a pitch setting of 2,400 DPI.

### (Evaluation)

### <Evaluation for Swelling Rate (Ink Resistance)>

The flexographic printing plate precursor was cut into a square of about 1 cm by 1 cm and put into a sample bottle. 2 mL of various inks were put into the bottle, and the bottle was allowed to standstill at 20° C. After 24 hours, the flexographic printing plate precursor was taken out, and the surface thereof was wiped. Then, the mass of the wiped precursor was measured, and a swelling rate was calculated by the following formula.

Swelling rate (mass %)=(mass measured after immersion)/(mass measured before immersion)×100

The closer the value to 100 mass %, the better.

The following was used as the inks.

Solvent ink: XA-55 (indigo) RE-28 (manufactured by SAKATA INX CORPORATION), SP value of 8.5 to 11.5

UV ink: UV Flexographic Indigo PHA (manufactured by T&K TOKA Corporation), SP value of 9.2 to 11.1

Aqueous ink: Aqua SPZ16 Crimson (manufactured by TOYO INK CO., LTD.), SP value of 11.5 to 23.4

The evaluation criteria are as below.

4: The swelling rate is lower than 105%.

3: The swelling rate is equal to or higher than 105% but lower than 110%.

2: The swelling rate is equal to or higher than 110% but lower than 115%.

1: The swelling rate is equal to or higher than 115%.

If the flexographic printing plate precursor is evaluated to be level 3 or a higher level, there is no problem in practical use.

### <Rinsing Properties for Engraving Residue>

The laser-engraved plate was immersed in a rinsing liquid, and the engraved portion was rubbed 10 times against a toothbrush (manufactured by Lion Corporation, Clinica toothbrush flat). Thereafter, the surface of relief layer was observed with an optical microscope so as to check the presence of residues. Regarding all of the examples and comparative examples, the present specification shows the results obtained when the semiconductor laser was used for engraving. However, even when the CO₂ laser was used, the same results were obtained.

The evaluation criteria are as below.

1: No residue

2: There is almost no residue.

3: Residue slightly remains.

4: Residue has not been removed.

If the flexographic printing plate precursor is evaluated to be level 3 or a higher level, there is no problem in practical use.

As the rinsing liquid, the following two kinds were used.

—Rinsing Liquid Having pH of Lower than 10—

Water, a 10 mass % aqueous sodium hydroxide solution, and a betaine compound (1-A) shown below were mixed together to prepare a rinsing liquid which had pH of 9 and contained the betaine compound (1-A) in an amount of 1 mass % of the entirety of the rinsing liquid.

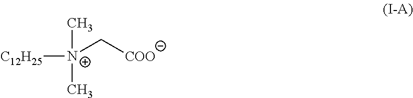

—Rinsing Liquid Having pH of Equal to or Higher than 10—

Water, a 10 mass % aqueous sodium hydroxide solution, and a betaine compound (1-B) shown below were mixed together to prepare a rinsing liquid which had pH of 12 and contained the betaine compound (1-B) in an amount of 1 mass % of the entirety of the rinsing liquid.

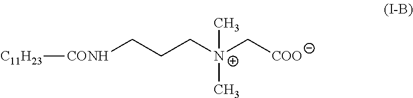

TABLE 1

| | | | | | | | | | Rinsing properties | |
|---|---|---|---|---|---|---|---|---|---|---|
| | | | | Component | | swelling rate | | | for engraving | |
| | Component A | | | B | | (ink resistance) | | | residue | |
| | Type | SP value | mass % | Type | mass % | solvent | UV | aqueous | <pH 10 | >pH 10 |
| Ex. 1 | A1-1 | 8.2 | 75 | B1-1 | 14 | 3 | 3 | 4 | 3 | 4 |
| Ex. 2 | A1-2 | 8.2 | 75 | B1-1 | 14 | 4 | 4 | 4 | 3 | 4 |
| Ex. 3 | A1-3 | 8.2 | 75 | B1-1 | 14 | 4 | 4 | 4 | 3 | 4 |
| Ex. 4 | A1-4 | 8.2 | 75 | B1-1 | 14 | 3 | 3 | 4 | 3 | 4 |
| Ex. 5 | A1-5 | 8.0 | 75 | B1-1 | 14 | 3 | 3 | 4 | 3 | 4 |
| Ex. 6 | A1-6 | 8.2 | 75 | B1-1 | 14 | 3 | 3 | 4 | 3 | 4 |
| Ex. 7 | A1-7 | 8.9 | 75 | B1-1 | 14 | 4 | 4 | 4 | 3 | 4 |
| Ex. 8 | A1-8 | 8.6 | 75 | B1-1 | 14 | 4 | 4 | 4 | 3 | 4 |
| Ex. 9 | A1-9 | 8.2 | 75 | B1-1 | 14 | 4 | 4 | 4 | 3 | 4 |
| Comp ex. 1 | A2-1 | 9.7 | 75 | B1-1 | 14 | 2 | 2 | 4 | 3 | 4 |
| Comp ex. 2 | A2-2 | 13.3 | 75 | B1-1 | 14 | 1 | 1 | 4 | 3 | 4 |
| Comp ex. 3 | A2-3 | 12.7 | 75 | B1-1 | 14 | 1 | 1 | 4 | 3 | 4 |
| Ex. 10 | A1-1 | 8.2 | 75 | B1-2 | 14 | 4 | 3 | 3 | 4 | 4 |
| Ex. 11 | A1-2 | 8.2 | 75 | B1-2 | 14 | 4 | 4 | 3 | 4 | 4 |
| Ex. 12 | A1-3 | 8.2 | 75 | B1-2 | 14 | 4 | 4 | 3 | 4 | 4 |
| Ex. 13 | A1-4 | 8.2 | 75 | B1-2 | 14 | 3 | 3 | 3 | 3 | 4 |
| Ex. 14 | A1-5 | 8.0 | 75 | B1-2 | 14 | 3 | 3 | 3 | 3 | 4 |
| Ex. 15 | A1-6 | 8.2 | 75 | B1-2 | 14 | 3 | 3 | 3 | 3 | 4 |
| Ex. 16 | A1-7 | 8.9 | 75 | B1-2 | 14 | 4 | 4 | 3 | 3 | 4 |
| Ex. 17 | A1-8 | 8.6 | 75 | B1-2 | 14 | 4 | 4 | 3 | 3 | 4 |
| Ex. 18 | A1-9 | 8.2 | 75 | B1-2 | 14 | 4 | 4 | 4 | 3 | 4 |
| Comp ex. 4 | A2-1 | 9.7 | 75 | B1-2 | 14 | 1 | 1 | 3 | 3 | 4 |
| Comp ex. 5 | A2-2 | 13.3 | 75 | B1-2 | 14 | 1 | 1 | 3 | 3 | 4 |
| Comp ex. 6 | A2-3 | 12.7 | 75 | B1-2 | 14 | 1 | 1 | 3 | 3 | 4 |
| Ex. 19 | A1-1 | 8.2 | 75 | B1-3 | 14 | 4 | 4 | 3 | 3 | 4 |
| Ex. 20 | A1-2 | 8.2 | 75 | B1-3 | 14 | 4 | 4 | 3 | 3 | 4 |
| Ex. 21 | A1-3 | 8.2 | 75 | B1-3 | 14 | 4 | 4 | 3 | 3 | 4 |
| Ex. 22 | A1-4 | 8.2 | 75 | B1-3 | 14 | 3 | 4 | 3 | 3 | 4 |
| Ex. 23 | A1-5 | 8.0 | 75 | B1-3 | 14 | 3 | 4 | 3 | 3 | 4 |
| Ex. 24 | A1-6 | 8.2 | 75 | B1-3 | 14 | 3 | 4 | 3 | 3 | 4 |
| Ex. 25 | A1-7 | 8.9 | 75 | B1-3 | 14 | 4 | 4 | 3 | 3 | 4 |
| Ex. 26 | A1-8 | 8.6 | 75 | B1-3 | 14 | 4 | 4 | 3 | 3 | 4 |
| Ex. 27 | A1-9 | 8.2 | 75 | B1-3 | 14 | 4 | 4 | 4 | 3 | 4 |
| Comp ex. 7 | A2-1 | 9.7 | 75 | B1-3 | 14 | 2 | 2 | 3 | 3 | 4 |
| Comp ex. 8 | A2-2 | 13.3 | 75 | B1-3 | 14 | 2 | 2 | 3 | 3 | 4 |
| Comp ex. 9 | A2-3 | 12.7 | 75 | B1-3 | 14 | 2 | 2 | 3 | 3 | 4 |
| Ex. 28 | A1-1 | 8.2 | 75 | B1-4 | 14 | 3 | 4 | 4 | 3 | 4 |
| Ex. 29 | A1-2 | 8.2 | 75 | B1-4 | 14 | 3 | 4 | 4 | 3 | 4 |
| Ex. 30 | A1-3 | 8.2 | 75 | B1-4 | 14 | 3 | 4 | 4 | 3 | 4 |
| Ex. 31 | A1-4 | 8.2 | 75 | B1-4 | 14 | 3 | 3 | 4 | 3 | 4 |
| Ex. 32 | A1-5 | 8.0 | 75 | B1-4 | 14 | 3 | 3 | 4 | 3 | 4 |
| Ex. 33 | A1-6 | 8.2 | 75 | B1-4 | 14 | 3 | 3 | 4 | 3 | 4 |
| Ex. 34 | A1-7 | 8.9 | 75 | B1-4 | 14 | 4 | 4 | 4 | 3 | 4 |
| Ex. 35 | A1-8 | 8.6 | 75 | B1-4 | 14 | 4 | 4 | 4 | 3 | 4 |
| Ex. 36 | A1-9 | 8.2 | 75 | B1-4 | 14 | 4 | 4 | 4 | 3 | 4 |
| Comp. ex. 10 | A2-1 | 9.7 | 75 | B1-4 | 14 | 2 | 2 | 4 | 3 | 4 |
| Comp. ex. 11 | A2-2 | 13.3 | 75 | B1-4 | 14 | 1 | 1 | 4 | 3 | 4 |
| Comp. ex. 12 | A2-3 | 12.7 | 75 | B1-4 | 14 | 1 | 1 | 4 | 3 | 4 |

TABLE 2

| | | | | | | | | | Rinsing properties | |
|---|---|---|---|---|---|---|---|---|---|---|
| | | | | Component | | swelling rate | | | for engraving | |
| | Component A | | | B | | (ink resistance) | | | residue | |
| | Type | SP value | mass % | Type | mass % | solvent | UV | aqueous | <pH 10 | >pH 10 |
| Ex. 37 | A1-1 | 8.2 | 75 | B1-5 | 14 | 3 | 4 | 4 | 3 | 4 |
| Ex. 38 | A1-2 | 8.2 | 75 | B1-5 | 14 | 3 | 4 | 4 | 3 | 4 |
| Ex. 39 | A1-3 | 8.2 | 75 | B1-5 | 14 | 3 | 4 | 4 | 3 | 4 |
| Ex. 40 | A1-4 | 8.2 | 75 | B1-5 | 14 | 3 | 3 | 4 | 3 | 4 |
| Ex. 41 | A1-5 | 8.0 | 75 | B1-5 | 14 | 3 | 3 | 4 | 3 | 4 |
| Ex. 42 | A1-6 | 8.2 | 75 | B1-5 | 14 | 3 | 3 | 4 | 3 | 4 |
| Ex. 43 | A1-7 | 8.9 | 75 | B1-5 | 14 | 3 | 4 | 4 | 3 | 4 |
| Ex. 44 | A1-8 | 8.6 | 75 | B1-5 | 14 | 3 | 4 | 4 | 3 | 4 |
| Ex. 45 | A1-9 | 8.2 | 75 | B1-5 | 14 | 3 | 4 | 4 | 3 | 4 |
| Comp ex. 13 | A2-1 | 9.7 | 75 | B1-5 | 14 | 2 | 2 | 4 | 3 | 4 |
| Comp ex. 14 | A2-2 | 13.3 | 75 | B1-5 | 14 | 1 | 1 | 4 | 3 | 4 |
| Comp ex. 15 | A2-3 | 12.7 | 75 | B1-5 | 14 | 1 | 1 | 4 | 3 | 4 |
| Ex. 46 | A1-1 | 8.2 | 75 | B1-6 | 14 | 3 | 3 | 4 | 3 | 4 |
| Ex. 47 | A1-2 | 8.2 | 75 | B1-6 | 14 | 3 | 4 | 4 | 3 | 4 |
| Ex. 48 | A1-3 | 8.2 | 75 | B1-6 | 14 | 3 | 4 | 4 | 3 | 4 |
| Ex. 49 | A1-4 | 8.2 | 75 | B1-6 | 14 | 3 | 3 | 4 | 3 | 4 |
| Ex. 50 | A1-5 | 8.0 | 75 | B1-6 | 14 | 3 | 3 | 4 | 3 | 4 |
| Ex. 51 | A1-6 | 8.2 | 75 | B1-6 | 14 | 3 | 3 | 4 | 3 | 4 |
| Ex. 52 | A1-7 | 8.9 | 75 | B1-6 | 14 | 3 | 3 | 4 | 3 | 4 |
| Ex. 53 | A1-8 | 8.6 | 75 | B1-6 | 14 | 3 | 3 | 4 | 3 | 4 |
| Ex. 54 | A1-9 | 8.2 | 75 | B1-6 | 14 | 3 | 3 | 4 | 3 | 4 |
| Comp ex. 16 | A2-1 | 9.7 | 75 | B1-6 | 14 | 2 | 2 | 4 | 3 | 4 |
| Comp ex. 17 | A2-2 | 13.3 | 75 | B1-6 | 14 | 1 | 1 | 4 | 3 | 4 |
| Comp ex. 18 | A2-3 | 12.7 | 75 | B1-6 | 14 | 1 | 1 | 4 | 3 | 4 |
| Ex. 55 | A1-1 | 8.2 | 75 | B1-7 | 14 | 3 | 3 | 4 | 3 | 4 |
| Ex. 56 | A1-2 | 8.2 | 75 | B1-7 | 14 | 3 | 4 | 4 | 3 | 4 |
| Ex. 57 | A1-3 | 8.2 | 75 | B1-7 | 14 | 3 | 4 | 4 | 3 | 4 |
| Ex. 58 | A1-4 | 8.2 | 75 | B1-7 | 14 | 3 | 3 | 4 | 3 | 4 |
| Ex. 59 | A1-5 | 8.0 | 75 | B1-7 | 14 | 3 | 3 | 4 | 3 | 4 |
| Ex. 60 | A1-6 | 8.2 | 75 | B1-7 | 14 | 3 | 3 | 4 | 3 | 4 |
| Ex. 61 | A1-7 | 8.9 | 75 | B1-7 | 14 | 3 | 3 | 4 | 3 | 4 |
| Ex. 62 | A1-8 | 8.6 | 75 | B1-7 | 14 | 3 | 3 | 4 | 3 | 4 |
| Ex. 63 | A1-9 | 8.2 | 75 | B1-7 | 14 | 3 | 4 | 4 | 3 | 4 |
| Comp ex. 19 | A2-1 | 9.7 | 75 | B1-7 | 14 | 2 | 2 | 4 | 3 | 4 |
| Comp ex. 20 | A2-2 | 13.3 | 75 | B1-7 | 14 | 1 | 1 | 4 | 3 | 4 |
| Comp ex. 21 | A2-3 | 12.7 | 75 | B1-7 | 14 | 1 | 1 | 4 | 3 | 4 |
| Ex. 64 | A1-1 | 8.2 | 75 | B1-8 | 14 | 3 | 3 | 4 | 3 | 4 |
| Ex. 65 | A1-2 | 8.2 | 75 | B1-8 | 14 | 3 | 4 | 4 | 3 | 4 |
| Ex. 66 | A1-3 | 8.2 | 75 | B1-8 | 14 | 3 | 4 | 4 | 3 | 4 |
| Ex. 67 | A1-4 | 8.2 | 75 | B1-8 | 14 | 3 | 3 | 4 | 3 | 4 |
| Ex. 68 | A1-5 | 8.0 | 75 | B1-8 | 14 | 3 | 3 | 4 | 3 | 4 |
| Ex. 69 | A1-6 | 8.2 | 75 | B1-8 | 14 | 3 | 3 | 4 | 3 | 4 |
| Ex. 70 | A1-7 | 8.9 | 75 | B1-8 | 14 | 3 | 3 | 4 | 3 | 4 |
| Ex. 71 | A1-8 | 8.6 | 75 | B1-8 | 14 | 3 | 3 | 4 | 3 | 4 |
| Ex. 72 | A1-9 | 8.2 | 75 | B1-8 | 14 | 3 | 4 | 4 | 3 | 4 |
| Comp. ex. 22 | A2-1 | 9.7 | 75 | B1-8 | 14 | 2 | 2 | 4 | 3 | 4 |
| Comp. ex. 23 | A2-2 | 13.3 | 75 | B1-8 | 14 | 1 | 1 | 4 | 3 | 4 |
| Comp. ex. 24 | A2-3 | 12.7 | 75 | B1-8 | 14 | 1 | 1 | 4 | 3 | 4 |

TABLE 3

| | | | | | | | | | Rinsing properties | |
|---|---|---|---|---|---|---|---|---|---|---|
| | | | | Component | | swelling rate | | | for engraving | |
| | Component A | | | B | | (ink resistance) | | | residue | |
| | Type | SP value | mass % | Type | mass % | solvent | UV | aqueous | <pH 10 | >pH 10 |
| Comp ex. 25 | A1-1 | 8.2 | 75 | B2-1 | 14 | 3 | 4 | 4 | 1 | 1 |
| Comp ex. 26 | A1-2 | 8.2 | 75 | B2-1 | 14 | 3 | 4 | 4 | 1 | 1 |
| Comp ex. 27 | A1-3 | 8.2 | 75 | B2-1 | 14 | 3 | 4 | 4 | 1 | 1 |
| Comp ex. 28 | A1-5 | 8.2 | 75 | B2-1 | 14 | 3 | 3 | 4 | 1 | 1 |
| Comp ex. 29 | A1-6 | 8.0 | 75 | B2-1 | 14 | 3 | 3 | 4 | 1 | 1 |
| Comp ex. 30 | A1-7 | 8.2 | 75 | B2-1 | 14 | 3 | 3 | 4 | 1 | 1 |
| Comp ex. 31 | A1-8 | 8.9 | 75 | B2-1 | 14 | 3 | 4 | 4 | 1 | 1 |
| Comp ex. 32 | A1-9 | 8.6 | 75 | B2-1 | 14 | 3 | 4 | 4 | 1 | 4 |
| Comp ex. 33 | A1-1 | 9.7 | 75 | B2-1 | 14 | 2 | 2 | 4 | 2 | 3 |
| Comp ex. 34 | A2-2 | 13.3 | 75 | B2-1 | 14 | 1 | 1 | 4 | 2 | 3 |
| Comp ex. 35 | A2-3 | 12.7 | 75 | B2-1 | 14 | 1 | 1 | 4 | 2 | 3 |
| Comp ex. 36 | A1-1 | 8.2 | 75 | B2-2 | 14 | 3 | 4 | 4 | 1 | 1 |
| Comp ex. 37 | A1-2 | 8.2 | 75 | B2-2 | 14 | 3 | 4 | 4 | 1 | 1 |
| Comp ex. 38 | A1-3 | 8.2 | 75 | B2-2 | 14 | 3 | 4 | 4 | 1 | 1 |
| Comp ex. 39 | A1-5 | 8.2 | 75 | B2-2 | 14 | 3 | 3 | 4 | 1 | 1 |
| Comp ex. 40 | A1-6 | 8.0 | 75 | B2-2 | 14 | 3 | 3 | 4 | 1 | 1 |
| Comp ex. 41 | A1-7 | 8.2 | 75 | B2-2 | 14 | 3 | 3 | 4 | 1 | 1 |
| Comp ex. 42 | A1-8 | 8.9 | 75 | B2-2 | 14 | 3 | 4 | 4 | 1 | 1 |
| Comp ex. 43 | A1-9 | 8.6 | 75 | B2-2 | 14 | 3 | 4 | 4 | 1 | 1 |
| Comp ex. 44 | A2-1 | 9.7 | 75 | B2-2 | 14 | 2 | 2 | 4 | 1 | 2 |
| Comp ex. 45 | A2-2 | 13.3 | 75 | B2-2 | 14 | 1 | 1 | 4 | 1 | 2 |
| Comp ex. 46 | A2-3 | 12.7 | 75 | B2-2 | 14 | 1 | 1 | 4 | 1 | 2 |
| Comp ex. 47 | A1-1 | 8.2 | 75 | B2-3 | 14 | 3 | 4 | 4 | 1 | 1 |
| Comp ex. 48 | A1-2 | 8.2 | 75 | B2-3 | 14 | 3 | 4 | 4 | 1 | 1 |
| Comp ex. 49 | A1-3 | 8.2 | 75 | B2-3 | 14 | 3 | 4 | 4 | 1 | 1 |
| Comp ex. 50 | A1-5 | 8.2 | 75 | B2-3 | 14 | 3 | 3 | 4 | 1 | 1 |
| Comp ex. 51 | A1-6 | 8.0 | 75 | B2-3 | 14 | 3 | 3 | 4 | 1 | 1 |
| Comp ex. 52 | A1-7 | 8.2 | 75 | B2-3 | 14 | 3 | 3 | 4 | 1 | 1 |
| Comp ex. 53 | A1-8 | 8.9 | 75 | B2-3 | 14 | 3 | 4 | 4 | 1 | 1 |
| Comp ex. 54 | A1-9 | 8.6 | 75 | B2-3 | 14 | 3 | 4 | 4 | 1 | 1 |
| Comp ex. 55 | A2-1 | 9.7 | 75 | B2-3 | 14 | 2 | 2 | 4 | 2 | 2 |
| Comp ex. 56 | A2-2 | 13.3 | 75 | B2-3 | 14 | 1 | 1 | 4 | 2 | 2 |
| Comp ex. 57 | A2-3 | 12.7 | 75 | B2-3 | 14 | 1 | 1 | 4 | 2 | 2 |

What is claimed is:

1. A resin composition for laser engraving comprising:
(Component A) a polymer having a monomer unit derived from a conjugated diene-based hydrocarbon;
(Component B) a compound having an acid group and an ethylenically unsaturated bond; and
(Component C) a polymerization initiator.

2. The resin composition for laser engraving according to claim 1,
wherein Component A contains a monomer unit derived from butadiene and/or isoprene.

3. The resin composition for laser engraving according to claim 1,
wherein Component B is a compound represented by the following Formula (1). 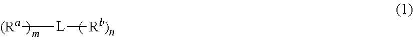
(In Formula (1), R^{a} denotes an ethylenically unsaturated bond; m denotes an integer from 1 to 3; R^{b} denotes an acid group; n denotes an integer of 1 or 2; and L denotes a single bond or an (m+n)-valent organic linking group which connects an ethylenically unsaturated bond and an acid group.)

4. The resin composition for laser engraving according to claim 2,
wherein Component B is a compound represented by the following Formula (1). 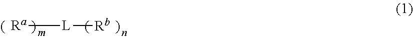
(In Formula (1), R^{a} denotes an ethylenically unsaturated bond; m denotes an integer from 1 to 3; R^{b} denotes an acid group; n denotes an integer of 1 or 2; and L denotes a single bond or an (m+n)-valent organic linking group which connects an ethylenically unsaturated bond and an acid group.)

5. The resin composition for laser engraving according to claim 1,
wherein Component B has two or more ethylenically unsaturated bonds.

6. The resin composition for laser engraving according to claim 2,
wherein Component B has two or more ethylenically unsaturated bonds.

7. The resin composition for laser engraving according to claim 1,
wherein the acid group that Component B has is selected from a group consisting of a carboxy group, a sulfonic acid group, and a phosphoric acid group.

8. The resin composition for laser engraving according to claim 4,
wherein Component B has two or more ethylenically unsaturated bonds, and the acid group that Component B has is selected from a group consisting of a carboxy group, a sulfonic acid group, and a phosphoric acid group.

9. The resin composition for laser engraving according to claim 6,
wherein the acid group that Component B has is selected from a group consisting of a carboxy group, a sulfonic acid group, and a phosphoric acid group.

10. The resin composition for laser engraving according to claim 1,
wherein the acid group that Component B has is a carboxy group.

11. The resin composition for laser engraving according to claim 4,
wherein Component B has two or more ethylenically unsaturated bonds, and the acid group that Component B has is a carboxy group.

12. The resin composition for laser engraving according to claim 6,
wherein the acid group that Component B has is a carboxy group.

13. The resin composition for laser engraving according to claim 1,
wherein an SP value of Component A is equal to or smaller than 9.0.

14. The resin composition for laser engraving according to claim 1, further comprising (Component D) a photothermal conversion agent.

15. A flexographic printing plate precursor for laser engraving comprising a crosslinked relief-forming layer obtained by crosslinking a relief-forming layer, which is formed of the resin composition for laser engraving according to claim 1, by heat and/or light.

16. The flexographic printing plate precursor for laser engraving according to claim 15,
wherein the crosslinked relief-forming layer is crosslinked by heat.

17. A process for producing a flexographic printing plate precursor for laser engraving, comprising steps of:
forming a relief-forming layer formed of the resin composition for laser engraving according to claim 1; and
crosslinking the relief-forming layer by heat and/or light so as to obtain a flexographic printing plate precursor having a crosslinked relief-forming layer.

18. The process for producing a flexographic printing plate precursor for laser engraving according to claim 17,
wherein in the step of crosslinking, the relief-forming layer is crosslinked by heat.

19. A process for making a flexographic printing plate, comprising steps of:
preparing the flexographic printing plate precursor for laser engraving according to claim 15; and
engraving the flexographic printing plate precursor for laser engraving with laser so as to form a relief layer.

20. A process for making a flexographic printing plate, comprising steps of:
preparing a flexographic printing plate precursor for laser engraving obtained by the production process according to claim 17; and
engraving the flexographic printing plate precursor for laser engraving with laser so as to form a relief layer.

21. The process for making a flexographic printing plate according to claim 19, further comprising, after the step of engraving, a step of rinsing the surface of the relief layer with an aqueous rinsing liquid.

22. The process for making a flexographic printing plate according to claim 21,
wherein pH of the aqueous rinsing liquid is equal to or higher than 10.

23. A flexographic printing plate made by the process for making a flexographic printing plate according to claim 19.
